(19) United States
(12) Patent Application Publication
(10) Pub. No.: US 2010/0284518 A1
(43) Pub. Date: Nov. 11, 2010

(54) PIVOTING HIGH FLUX X-RAY TARGET AND ASSEMBLY

(76) Inventors: Anupam Singh Ahlawat, Bangalore (IN); Prasad Balaji Narasimha Paturi, Bangalore (IN)

Correspondence Address: General Electric Company;GE Global Patent Operation, 2 Corporate Drive, Suite 648, Shelton, CT, 06484, US

(21) Appl. No.: 12/810,871

(22) PCT Filed: Dec. 31, 2007
(86) PCT No.: PCT/IN2007/000625

§ 371 Date: Jun. 28, 2010

(51) Int. Cl. H01J 35/28; H01J 35/08

(52) U.S. Cl. 378/126; 378/143

(57) ABSTRACT

A high flux X-ray tube anode target assembly (101). The assembly includes a support shaft (107) connected to a pivot assembly (109). The assembly further includes a movable anode target (105) having a target surface (106) disposed at one end of the support shaft. The target surface includes a single radius of curvature. The radius of curvature extends from a pivot point (110). The assembly also includes a drive member (119) operably arranged with respect to the support shaft to provide motion to the anode target. The assembly is configured to maintain a substantially fixed distance between the pivot point and the target surface.

### FIELD OF THE INVENTION

This disclosure relates to an X-ray tube anode target assembly and, more particularly, to configuration and structures for imparting pivoting motion to an X-ray tube anode target assembly.

### BACKGROUND

Ordinarily an X-ray beam-generating device referred to as an X-ray tube comprises dual electrodes of an electrical circuit in an evacuated chamber or tube. One of the electrodes is an electron emitter cathode which is positioned in the tube in spaced relationship to an anode target. Energization of the electrical circuit generates a stream or beam of electrons directed towards the anode target. This acceleration is generated from a high voltage differential between the anode and cathode that may range from 60-450 kV, which is a function of the imaging application. The electron stream is appropriately focused as a thin beam of very high velocity electrons striking the anode target surface. The anode surface ordinarily comprises a predetermined material, for example, a refractory metal so that the kinetic energy of the striking electrons against the target material is converted to electromagnetic waves of very high frequency, i.e. X-rays, which proceed from the target to be collimated and focused for penetration into an object usually for internal examination purposes, for example, industrial inspection procedures, healthcare imaging and treatment, or security imaging applications, food processing industries. Imaging applications include, but are not limited to, Radiography, CT, X-ray Diffraction with Cone and Fan beam x-ray fields.

Well-known primary refractory and non-refractory metals for the anode target surface area exposed to the impinging electron beam include copper (Cu), Fe, Ag, Cr, Co, tungsten (W), molybdenum (Mo), and their alloys for X-ray generation. In addition, the high velocity beam of electrons impinging the target surface generates extremely high and localized temperatures in the target structure accompanied by high internal stresses leading to deterioration and breakdown of the target structure. As a consequence, it has become a practice to utilize a rotating anode target generally comprising a shaft supported disk-like structure, one side or face of which is exposed to the electron beam from the thermionic emitter cathode. By means of target rotation, the impinged region of the target is continuously changing to avoid localized heat concentration and stresses and to better distribute the heating effects throughout the structure. Heating remains a major problem in X-ray anode target structures. In a high speed rotating target, heating must be kept within certain proscribed limits to control potentially destructive thermal stresses particularly in composite target structures, as well as to protect low friction, solid lubricated, high precision bearings that support the target.

Only about 1.0% of the energy of the impinging electron beam is converted to X-rays with the remainder appearing as heat, which must be rapidly dissipated from the target essentially by means of heat radiation. Accordingly, significant technological efforts are expended towards improving heat dissipation from X-ray anode target surfaces. For most rotating anode targets heat management must take place principally through radiation and a material with a high heat storage capacity. Stationary anode target body configurations or some complex rotating anode target configurations may be designed to have heat transfer primarily take place using conduction or convection from the target to the x-ray tube. Life of rotating x-ray targets are often gated by the complexities of rotation in a vacuum. Traditional x-ray target bearings are solid lubricated, which have relatively low life. Stationary targets do not have this life-limiting component, at the cost of lower performance.

Other rotation components, solid lubricated bearings, ferro-fluid seals, spiral-grooved liquid metal bearings, etc, all introduce manufacturing complexity and system cost.

What is needed is a high flux X-ray tube configuration that provides oscillating motion to the target and includes components capable of maintaining an extended life, with a limited introduction of cost and manufacturing complexity.

### SUMMARY OF THE DISCLOSURE

One aspect of the present disclosure includes a high flux X-ray tube anode target assembly. The assembly includes a support shaft connected to a pivot assembly. The assembly further includes a movable anode target having a target surface disposed at one end of the support shaft. The target surface includes a single radius of curvature. The radius of curvature extends from a pivot point. The assembly also includes a drive member operably arranged with respect to the support shaft to provide motion to the anode target. The assembly is configured to maintain a substantially fixed distance between the pivot point and the target surface.

Another aspect of the disclosure includes an X-ray tube assembly having an envelope having at least a portion thereof substantially transparent to X-ray. A cathode assembly is operatively positioned in the envelope with an anode assembly. The anode assembly includes a support shaft connected to a pivot assembly and a movable anode target having a target surface disposed at one end of the support shaft, the target surface having a single radius of curvature. The radius of curvature extends from a pivot point. A drive member is operably arranged with respect to the support shaft to provide motion to the anode target and the assembly is configured to maintain a substantially fixed distance between the pivot point and the target surface.

Another aspect of the disclosure includes a method for providing heat management to an X-ray assembly. The method includes providing an X-ray tube assembly having an envelope having at least a portion thereof substantially transparent to X-ray. The assembly also includes a cathode assembly, operatively positioned in the envelope. The assembly also includes an anode assembly having a support shaft connected to a pivot assembly and a movable anode target having a target surface disposed at one end of the support shaft, the target surface having a single radius of curvature. The radius of curvature extends from a pivot point. A drive member is operably arranged with respect to the support shaft to provide motion to the anode target. The method further includes pivoting the anode target assembly and maintaining a substantially fixed distance between the pivot point and the target surface.

The position of the focal point along the surface of the target is varied, providing improved heat management, wherein the heat may be dissipated more easily. In addition, the increased dissipation permits the use of higher power and longer durations than are available with the use of a stationary anode arrangement. In addition, the anode has increased life over anodes that have a fixed focal point on the anode. The anode target motion provides longer life than solid lubricated bearings used in known rotating anode sources.

Another advantage of the present disclosure includes the reduction or elimination in dwell or delay time for anode motion reducing or eliminating heat build up due to reversal of direction. In addition, cooling may be accomplished primarily or exclusively through radiative cooling.

Still another advantage of the present disclosure is that the motion may be provided by simple control algorithms and low torque requirements for the drive assembly. In addition, compensation for slight alignment and operating errors can easily be incorporated into the control and/or design.

Additionally, the assembly will have reduced manufacturing complexity, and cost, in comparison to conventional rotational bearing arrangements.

The assembly of the present disclosure may allow multiple spots to be placed on a single target, in that each region will be thermally isolated from the neighboring spot, while maintaining the benefit of higher power through oscillatory motion from a single drive mechanism.

Embodiments of the present disclosure also allow the distribution of heat over a larger area of the anode target, through the oscillating motion, which reduces the peak temperature and maintains the temperature below the evaporation limit for the metal in the envelope, and reduces the temperature gradient between surface and substrate.

Other features and advantages of the present disclosure will be apparent from the following more detailed description of the preferred embodiment, taken in conjunction with the accompanying drawings which illustrate, by way of example, the principles of the disclosure.

### BRIEF DESCRIPTION OF THE DRAWINGS

FIG. 1 shows an elevational side view of an X-ray tube assembly according to an embodiment of the present disclosure.

FIG. 2 shows a top perspective view of an X-ray tube assembly according to an embodiment of the present disclosure.

FIG. 3 shows an elevational view of a pivot assembly according to an embodiment of the present disclosure.

FIG. 4 shows an oscillatory coupling according to an embodiment of the present disclosure.

FIG. 5 shows a view of an anode assembly taken along line 5-5 of FIG. 4 according to an embodiment of the present disclosure.

FIG. 6 shows an anode target assembly according to an embodiment of the present disclosure.

FIG. 7 shows a view of an anode target assembly taken along line 7-7 of FIG. 6 according to an embodiment of the present disclosure.

FIG. 8 shows an anode target assembly according to another embodiment of the present disclosure.

FIG. 9 shows a view of an anode target assembly taken along line 9-9 of FIG. 8 according to an embodiment of the present disclosure.

Wherever possible, the same reference numbers will be used throughout the drawings to refer to the same or like parts.

### DETAILED DESCRIPTION

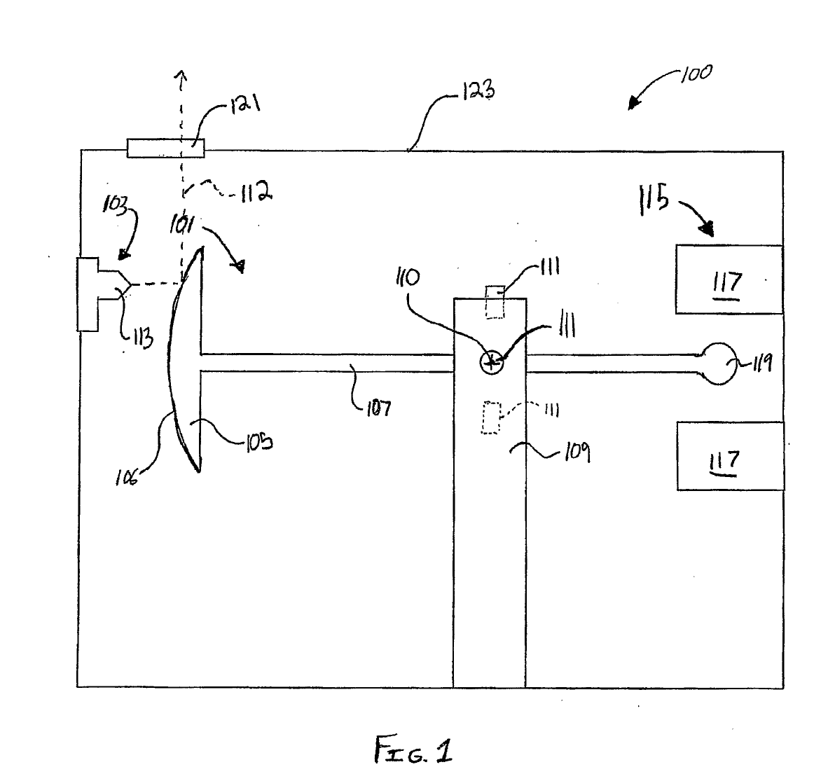

FIG. 1 is a schematic elevational view of an X-ray tube assembly 100 having an anode assembly 101 and a cathode assembly 103. The anode assembly 101 and cathode assembly 103 are arranged in a manner, through thermionic or field-emission electron generation, that permits formation of X-rays, during X-ray tube assembly 100 operation. The anode assembly 101 includes an anode target 105 mounted on a support shaft 107. The anode target 105 is fabricated from any material suitable for use as an anode target, such as, but not limited to copper (Cu), iron (Fe), silver (Ag), chromium (Cr), cobalt (Co), tungsten (W), molybdenum (Mo), and their alloys. For example, tungsten or molybdenum having additive refractory metal components, such as, tantalum, hafnium, zirconium and carbon may be utilized. The suitable materials may also include oxide dispersion strengthened molybdenum and molybdenum alloys, which may further include the addition of graphite to provide additional heat storage. Further still, suitable material may include tungsten alloys having added rhenium to improve ductility of tungsten, which may be added in small quantities (e.g., 1 to 10 wt %).

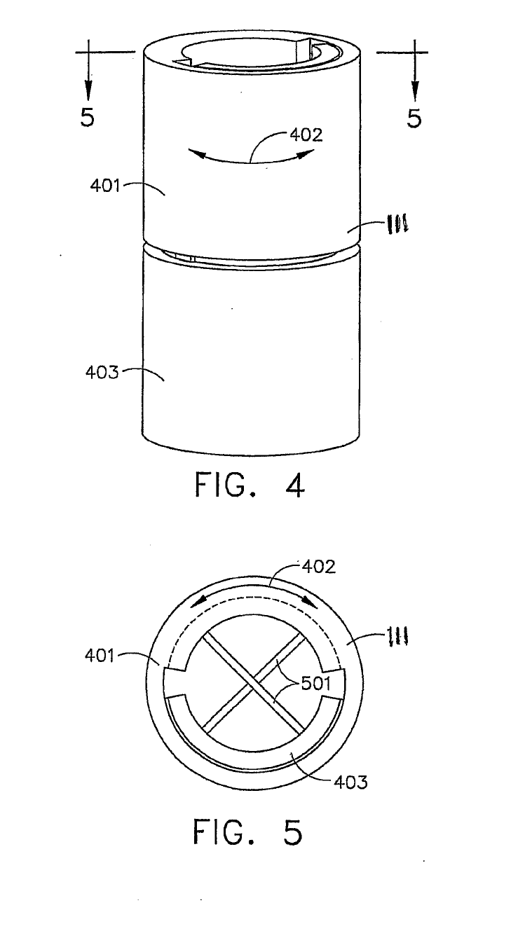

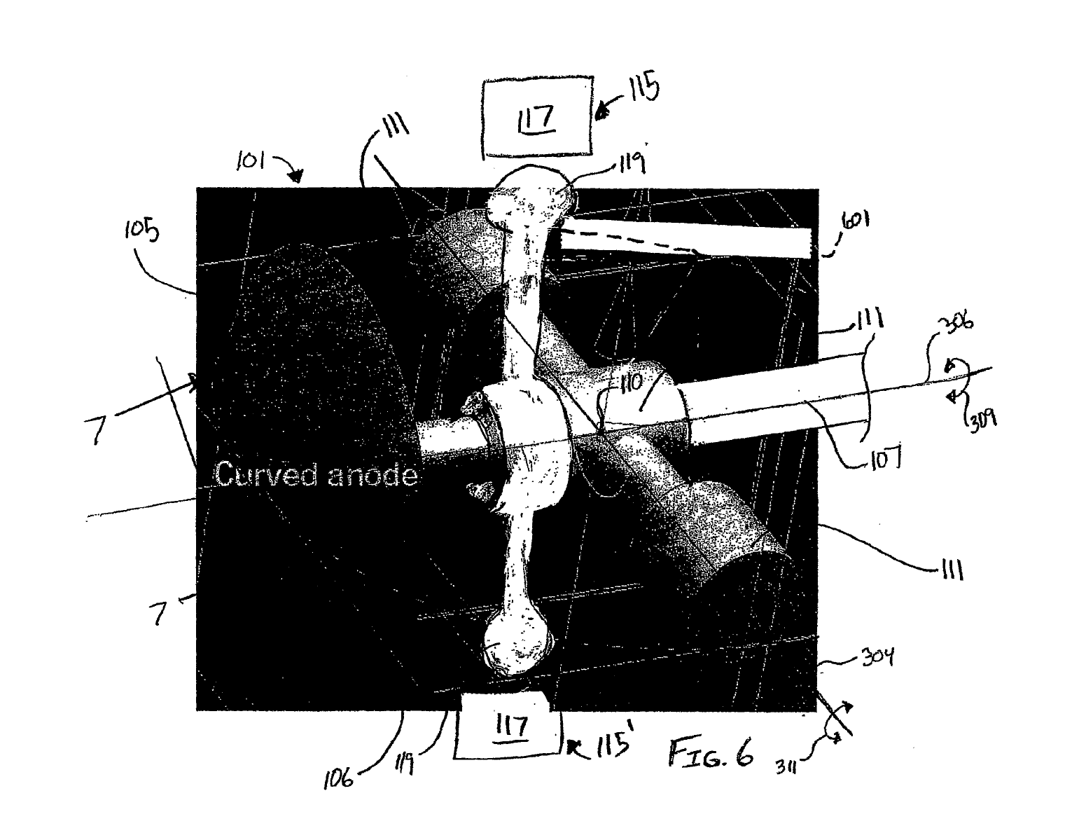

The support shaft 107 is mounted on a pivot assembly 109 with one or more oscillatory couplings 111 (see e.g., FIGS. 4-5). The oscillatory coupling 111 includes a first segment 401 (see FIG. 4) that is attached to the support shaft 107 and a second segment 403 (see FIG. 4) of the oscillatory coupling 111 attached to the pivot assembly 109, is permitted to oscillate. The use of a plurality of oscillatory couplings 111 permits the anode target 105 to pivot about a center pivot point 110 with rotation about two axes. The pivot point 110 is a point about which axis of pivoting or rotation intersect or otherwise the point about which the pivoting or rotation takes place. By “pivot”, “pivoting” and grammatical variations thereof, it is meant to be a rotary or turning motion about a single location or single area. By “oscillatory”, “oscillation” and grammatical variations thereof, it is meant to include swaying motion to and fro, rotation or pivoting on an axis between two or more positions and/or motion including periodic changes in direction.

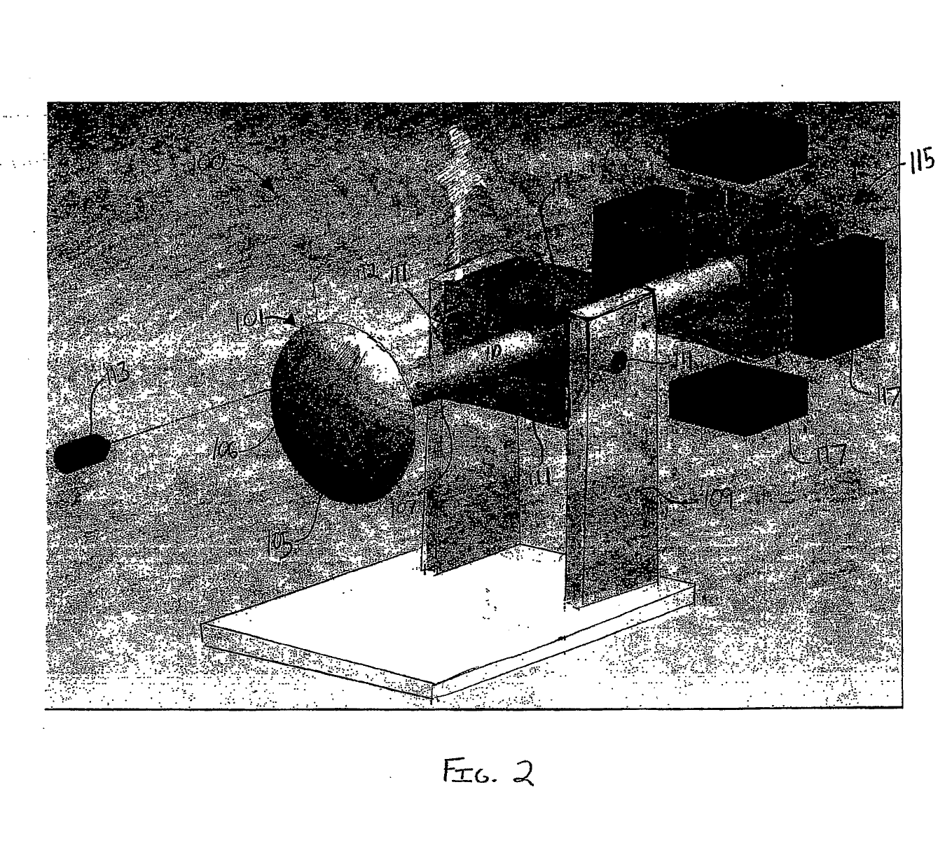

The anode target 105 includes a target surface 106, which is curved with a single radius of curvature across the entire target surface 106. Although FIG. 1-2 includes a spherical segment geometry for the target surface 106, other geometries may be utilized as long as the radius of curvature remains fixed across the entire target surface. Other suitable geometries include, but are not limited to spherical, hemi-spherical, semi-spherical, partial spherical, or spherical segment geometry. The target surface 106 is the surface onto which an electron beam 112 is directed. The electron beam 112 is directed to the target surface 106 from cathode assembly 103.

The cathode assembly 103 comprises an electron emissive portion 113. The disclosure is not limited to the arrangement shown, but may be any arrangement and/or geometry that permits the formation of an electron beam at the electron emissive portion 113. Conductors or other current supplying mechanism may be included in the cathode assembly 103 to supply heating current to a filament and/or conductor present in the cathode assembly for maintaining the cathode at ground or negative potential relative to the anode target 105 of the tube assembly 100. An electron beam 112 from the electron emissive portion 113 impinges upon target 105 at a focal point on the target surface 106 to produce X-radiation. The target surface 106 is configured with a substantially uniform radius of curvature to provide a substantially constant angle of impingement by the electron beam 112, throughout the anode target 105 motion. The beam 112 produces X-radiation by impingement on target 105, wherein the X-radiation is directed through window 121.

At least a portion of the envelope 123 acts as a window 121 for the X-rays. The window 121 may be fabricated from glass or other material substantially transparent to X-rays. The configuration of the envelope 123 may be any configuration suitable for providing the X-radiation to the desired locations and may be fabricated from conventionally utilized materials.

The focal point may be a single point or an area having any suitable geometry corresponding to the electron emissions from the electron emissive potion 113. Additionally, the focal point may have movement introduced into the beam from electrostatic, magnetic or other steering method. In addition, the focal point may be of constant size and/or geometry or may be varied in size and/or geometry, as desired for the particular application. “X-ray”, “X-radiation” and other grammatical variations as utilized herein mean electromagnetic radiation with a wavelength in the range of about 10 to 0.01 nanometers or other similar electromagnetic radiation. Heat is generated along the target surface 106 at the point of electron beam contact (i.e., the focal point). The anode target 105 is oscillated by drive assembly 115, which may include, but is not limited to, an induction or otherwise magnetically or mechanically driven drive mechanism. Suitable drive assemblies 115 may include, but are not limited to, voice-coil actuators or switched reluctance motors (SRM) drive. The drive assembly 115 may further include cams or other structures to convert linear, rotational or other motion to oscillatory motion.

The drive assembly 115 includes an arrangement capable of providing oscillatory motion to the target 105. In the arrangement shown, the drive assembly 115 includes a magnetically driven motor arrangement, including fixed stator portions 117 and a movable ball portion 119. The movable ball portion 119 is preferably a ferromagnetic or otherwise magnetic material that is capable of attraction to the stator portions 117 upon electromagnetic activation thereof. The ball portion 119 is disposed at a distal end of the support shaft 107 to the target 105. The drive assembly 115 is operably arranged to provide the oscillatory motion for the attached target 105. The present disclosure is not limited to the arrangement of drive assembly 115 shown and may include any arrangement capable of providing pivoting motion to the target 105.

The movement of the target 105 provided by the drive assembly 115 is such that the focal point on the target surface 106 provides a substantially constant X-ray emission, wherein the target 105 moves relative to the focal point. In addition, the angle of incidence for the electron beam is maintained during anode target motion 105. Specifically, the drive assembly 115 provides motion to target 105 such that the focal point remains at a substantially fixed distance from the electron emissive portion 113 and/or the angle at which the electron beam impinges the target 105 remains substantially constant. The present disclosure is not limited to reflection based geometry for X-ray generation, but may include alternate configurations, such as anode target 105 configured for transmission generated X-rays. The anode assembly 101 and the cathode assembly 103 are housed in an envelope 123, which is under vacuum or other suitable atmosphere.

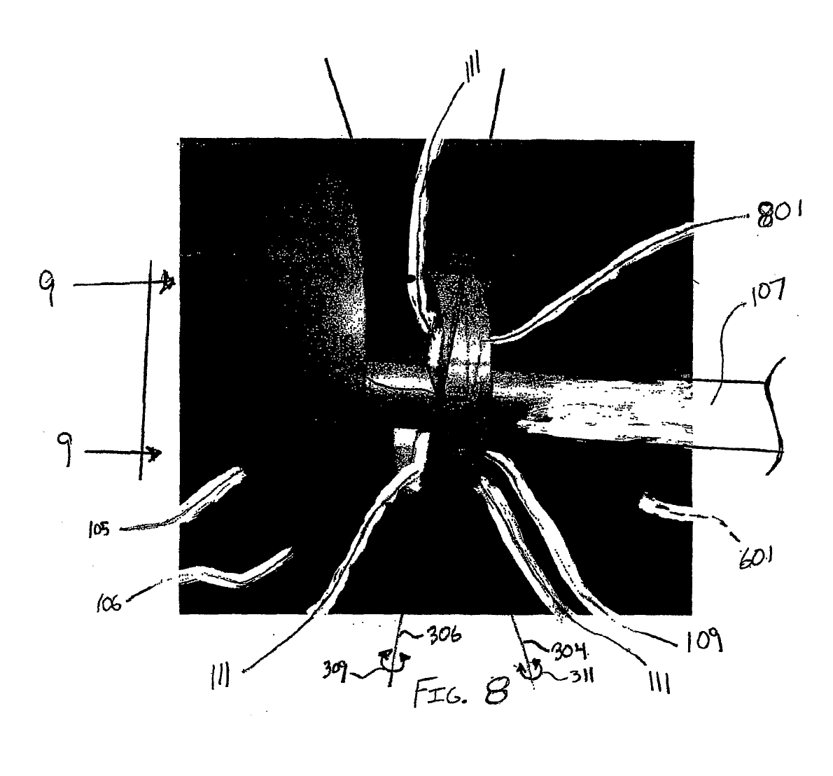

FIG. 2 shows a top perspective view of an X-ray tube assembly 100 having substantially the same arrangement as shown and describe in FIG. 1. As shown in FIG. 2, the pivot assembly 109 permits pivoting of the support shaft 107, which thereby moves anode target 105. Further, the drive assembly 115 includes a plurality of stator portions 117 arranged in a substantially circumferential arrangement about the ball portion 119. The activation of the stator portions 117 induces the anode target 105 pivoting motion. The use of a plurality of oscillatory couplings 111 permits the anode target 105 to pivot about a center pivot point 110 with rotation about two axes. One skilled in the art would also understand that this pivotal motion may also be provided utilizing bearing configurations. The drive assembly 115 may be controlled by any suitable control arrangement including microprocessor or other control device, wherein the motions may be controlled to provide the desired pivoting motion in order to provide a focal path 700 (see e.g., FIGS. 7 and 9) that permits heat dissipation and minimize or eliminate heat generated damage to the target surface 106.

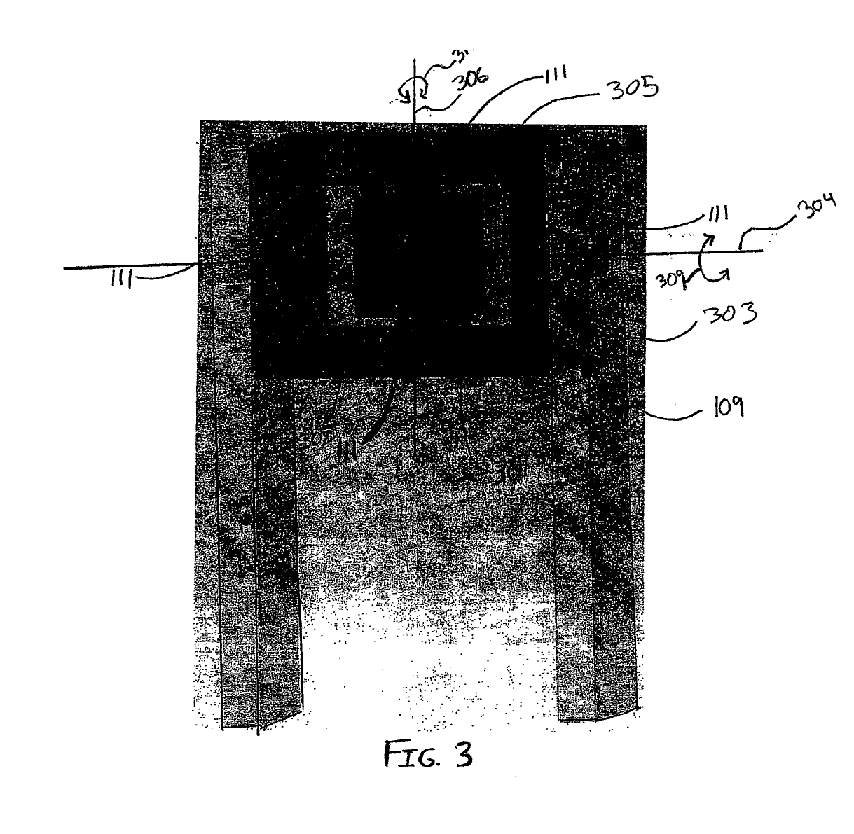

FIG. 3 shows a pivot assembly 109 according to an embodiment of the present disclosure. The pivot assembly 109 is configured to allow the pivoting of the support shaft 107 supported in opening 301. Four oscillatory couplings 111 are arranged to provide pivoting of the support shaft 107 about two axes. The arrangement of the oscillatory couplings 111 includes two oscillatory couplings 111 affixed to a first pivot support member 303 and a second pivot support member 305. The arrangement of the oscillatory couplings 111 between the first pivot support member 303 and a second pivot support member 305 permits oscillatory motion about a first axis 304. In addition, the arrangement of the oscillatory couplings 111 includes two oscillatory couplings 111 affixed to the second pivot support member 305 and a third pivot support member 307, onto which the support shaft 107 is mounted. The first axis 304 and second axis are arranged substantially perpendicular to each other. The arrangement of the oscillatory couplings 111 between the second pivot support member 305 and a third pivot support member 307 permits oscillatory motion about a second axis 306. The first rotational motion 309 is about first axis 304 and the second rotational motion 311 is about second axis 306. The combination of the rotations permits pivoting of the anode target 105 through large range of motion. While FIG. 1-3 shows four oscillatory couplings 111, the present invention may utilize any number of oscillatory couplings 111 that provide the desired pivoting movement of the anode target 105.

FIG. 4 shows an oscillatory coupling 111 for use in an embodiment of the disclosure. The oscillatory coupling 111 provides a spring-like back and forth oscillatory motion 402 between segments 401, 403 of the oscillatory coupling 111. The oscillatory coupling 111 includes a first segment 401 that rotates with respect to a second segment 403 by segment oscillation 402. During oscillation, the second segment 403 remains substantially stationary. In particular, the second segment 403 is attached to a fixture or other support that retards movement of the second segment 403, while first segment 401 is permitted to oscillate. FIG. 5 shows oscillatory coupling 111 taken along 5-5 of FIG. 4. The oscillatory coupling 111 provides oscillatory motion 402 by a coupling mechanism 501 between the first segment 401 and the second segment 403. The coupling mechanism 501 may be one or more spring or force providing or otherwise flexible devices that provide connection between segments 401, 403 and reciprocating motion between segments 401, 403. In the embodiment shown in FIGS. 1-3, a linear spring is utilized to provide flexing sufficient to provide oscillatory motion 402. The oscillatory coupling mechanism 501 may include linear springs selected to introduce motion that may be varied for desired frequency, angle and path radii.

Coupling mechanisms 501, for example, utilizing linear springs to provide oscillation, may have up to infinite life spans for a prescribed radial load and oscillating angle, which life spans are difficult or impossible in known rotary motion assemblies. During operation of X-ray tube assembly 100, the drive assembly 115, which is configured to pivot the target 105 in a manner that results in flexing of the coupling mechanism 501 of the corresponding oscillatory couplings 111, which, permits motion of the first segment 401 (i.e. oscillation 402) with respect to the second segment 403. The oscillation of the first segment 401 provides target 105 with motion desirable for heat management.

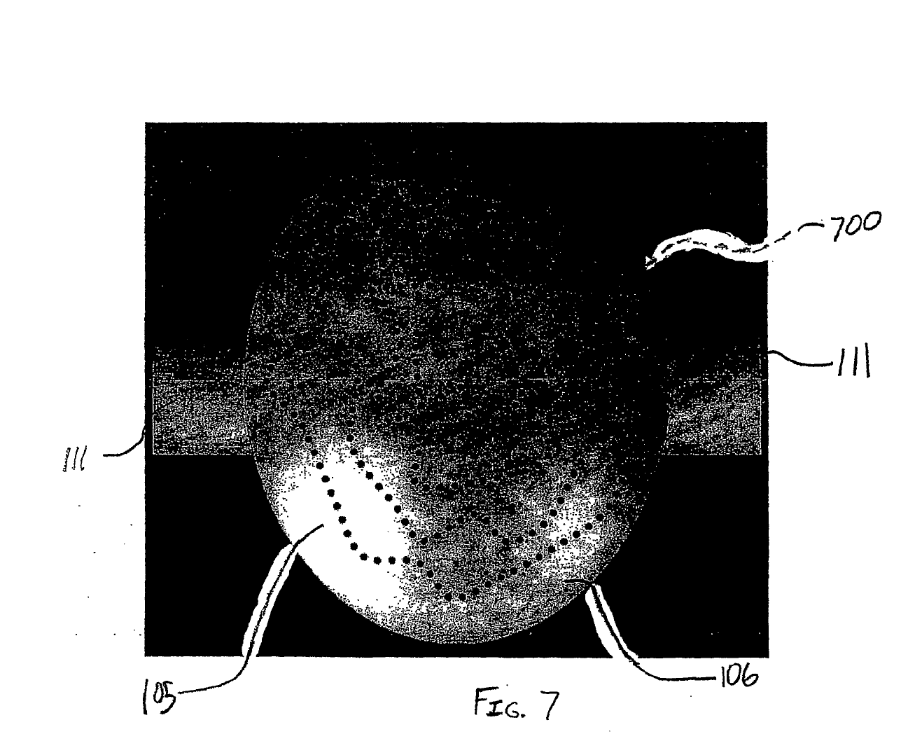

FIG. 6 shows an anode target assembly 101 according to another embodiment of the present disclosure. The anode target assembly 101 shown has a similar arrangement to the arrangement shown in FIG. 1, including a drive assembly 115 (not shown) to provide a rotational motion 311 about first axis 304. The target surface 106 includes a spherical segment, wherein the spherical segment includes a portion of a sphere. The target assembly 101 includes two oscillatory couplings 111 mounted to the housing or other structure within the X-ray tube assembly 100 (see e.g., FIG. 1). The oscillatory couplings 111 mounted to the housing are further mounted to another oscillatory coupling 111 mounted on support shaft 107. The use of a plurality of oscillatory couplings 111 permits the anode target 105 to pivot about a center pivot point 110 with rotation about two axes. The oscillatory couplings 111 are arranged to permit oscillatory motion about first axis 304 and about second axis 306. In addition, the embodiment shown in FIG. 6 includes a drive assembly 115′, which, like drive assembly 115, includes a stator portion 117 and a ball portion 119. The ball portion 119 is connected to drive assembly 115′ and provides a rotational motion 309 about second axis 306. The resulting pivoting motion permits movement of the anode target 105 through a range of motion. The pivoting motion is constrained such that the target surface 106 remains at a fixed, single radius of curvature 601. The motion of the anode target 105 provides a moving focal point or focal path 700 (see e.g., FIG. 7), which permits dissipation of heat over a large area of target surface 106.

FIG. 7 shows a view of an anode target assembly taken along line 7-7 of FIG. 6 according to an embodiment of the present disclosure. The target surface 106 preferably provides an aspect angle to which the electron beam 112 impinges (see e.g., FIGS. 1-2) that is substantially constant and directs the X-radiation in the desired direction throughout the motion of the target 105. Since the position along the anode target 105 (i.e., focal path 700) is varied, the heat generated by the impingement of the electrons on the anode target 105 is permitted to dissipate over a larger area. This dissipation of heat permits the use of higher power and longer durations than are available with the use of a stationary anode arrangement. The target 105 is not limited to the geometry shown and may include segmented or otherwise curved geometry anode targets 105, for example, while not so limited, targets 105 may have a “butterfly” shape, or a multi-spot curved geometry, provided the target surface utilized maintains the substantially constant radius of curvature 601.

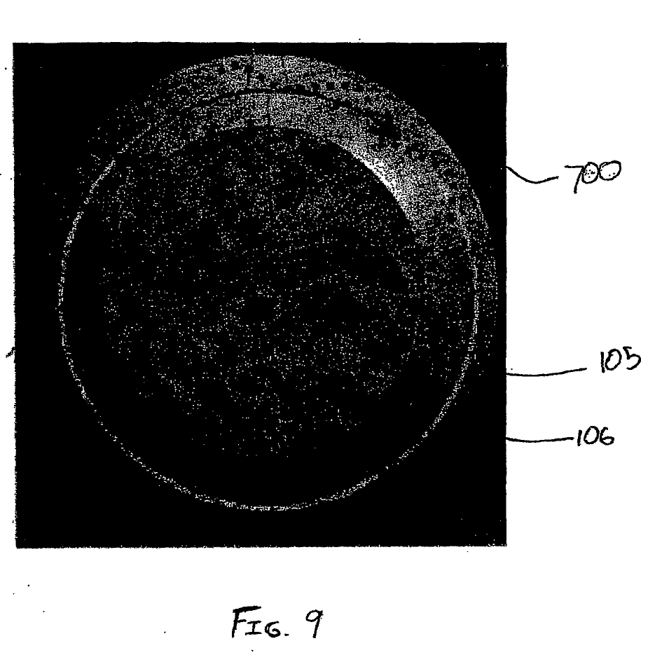

FIG. 8 shows an anode target assembly 101 according to another embodiment of the present disclosure. The anode target assembly 101 shown has a similar arrangement to the arrangement shown in FIG. 1, including a drive assembly 115 (not shown) to provide a rotational motion 309 about first axis 304 and second axis 306. The use of a plurality of oscillatory couplings 111 permits the anode target 105 to pivot about a center pivot point 110 with rotation about two axes. The pivoting motion is provided by a pivot assembly 109 made up of a ring 801 having an arrangement of four oscillatory couplings 111. Two of the oscillatory couplings 111 are mounted to the housing or other structure within the X-ray tube assembly 100 (see e.g., FIG. 1). Another two oscillatory couplings 111 are arranged with portions affixed to the ring 801 and support shaft 107, respectively. The resulting pivoting motion permits movement of the anode target through a range of motion. The pivoting motion is constrained such that the anode surface 106 remains at a fixed, single radius of curvature 601. The motion of the anode target 105 provides a moving focal point or focal path 700 (see e.g., FIG. 9), which permits dissipation of heat over a large area of target surface 106.

FIG. 9 shows a view of an anode target assembly 101 taken along line 7-7 of FIG. 6 according to an embodiment of the present disclosure. The target surface 106 includes a spherical segment, wherein the spherical segment includes a portion of a sphere bounded by two substantially parallel planes passing through the sphere. The target surface 106 preferably provides an aspect angle to which the electron beam 112 impinges (see e.g., FIGS. 1-2) that is substantially constant and directs the X-radiation in the desired direction throughout the motion of the target 105. Since the position along the anode target surface 106 (i.e., focal path 700) is varied, the heat generated by the impingement of the electrons on the anode target 105 is permitted to dissipate over a larger area. This dissipation of heat permits the use of higher power and longer durations than are available with the use of a stationary anode arrangement.

Also, as discussed above, the particular arrangement of oscillatory couplings 111 or other pivoting structures is not limited the arrangements shown and may include any pivoting or oscillatory motion providing structure that is capable of pivoting the anode target in at least two axes. Further, the present disclosure is not limited to pivoting motion provided through the use of a plurality of oscillatory coupling 111, but also includes direct actuation of the anode target 105 in a motion maintaining a fixed distance from the pivot point. For example, the anode target 105 may be affixed to a drive assembly 115, wherein the drive assembly 115 provides reciprocating rotation or oscillation of the anode target 105, such that the target surface 106 provides substantially constant production of X-rays from the electron beam 112. Further a cam or similar device may be utilized to translate additional rotational or other motion to the anode target 105. In addition, the present disclosure is not limited to the geometry of the targets shown and may include target geometries that are asymmetrical or other non-circular arrangements. Further still, the present disclosure is not limited to a single focal point and may include multiple focal points.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. An X-ray tube anode target assembly comprising:
a support shaft connected to a pivot assembly;
a movable anode target having a target surface disposed at one end of the support shaft, the target surface having a single radius of curvature, the radius of curvature extending from a pivot point;
a drive member operably arranged with respect to the support shaft to provide motion to the anode target; and
wherein the assembly is configured to maintain a substantially fixed distance between the pivot point and the target surface.

2. The anode assembly of claim 1, wherein the target surface is configured with a spherical segment geometry.

3. The anode assembly of claim 1, wherein the target surface is configured to provide a reflection X-ray generation.

4. The anode assembly of claim 1, wherein the target surface is configured to provide a transmission X-ray generation.

5. The anode assembly of claim 1, wherein the target is arranged at an angle to the cathode assembly, the angle remaining substantially constant during oscillatory motion.

6. Anode assembly of claim 1, wherein the target has two or more segments each comprising the target surface.

7. The anode assembly of claim 1, wherein the drive member includes an induction motor to provide oscillation to the target.

8. An X-ray tube assembly comprising:
an envelope having at least a portion thereof substantially transparent to X-ray;
a cathode assembly, operatively positioned in the envelope with an anode assembly comprising:
a support shaft connected to a pivot assembly;
a movable anode target having a target surface disposed at one end of the support shaft, the target surface having a single radius of curvature, the radius of curvature extending from a pivot point;
a drive member operably arranged with respect to the support shaft to provide motion to the anode target; and
wherein the assembly is configured to maintain a substantially fixed distance between the pivot point and the target surface.

9. The X-ray tube assembly of claim 8, wherein the target surface is configured with a spherical segment geometry.

10. The X-ray tube assembly of claim 8, wherein the cathode assembly and target surface are configured to provide a single focal point.

11. The X-ray tube assembly of claim 8, wherein the cathode assembly and target surface are configured to provide multiple focal points.

12. The X-ray tube assembly of claim 8, wherein the target surface is configured to provide a reflection X-ray generation.

13. The X-ray tube assembly of claim 8, wherein the target surface is configured to provide a transmission X-ray generation.

14. The X-ray tube assembly of claim 8, further comprising an oscillatory coupling between the drive member and the target.

15. The X-ray tube assembly of claim 14, wherein the oscillatory coupling includes a substantially linear coupling.

16. The X-ray tube assembly of claim 8, wherein the target is arranged at an angle to the cathode assembly, the angle remaining substantially constant during motion.

17. The X-ray tube assembly of claim 8, wherein the drive member includes an induction motor to provide oscillation to the target.

18. A method for providing heat management to an X-ray assembly comprising:
providing an X-ray tube assembly having:
an envelope having at least a portion thereof substantially transparent to X-ray;
a cathode assembly, operatively positioned in the envelope;
an anode assembly comprising:
a support shaft connected to a pivot assembly;
a movable anode target having a target surface disposed at one end of the support shaft, the target surface having a single radius of curvature, the radius of curvature extending from a pivot point;
a drive member operably arranged with respect to the support shaft to provide motion to the anode target; and
pivoting the anode target assembly and maintaining a substantially fixed distance between the pivot point and the target surface.

19. The method of claim 18, wherein the pivoting includes a rotationally motion about an axis substantially parallel to the support shaft.

20. The method of claim 18, wherein the pivoting includes an oscillatory motion about two substantially perpendicular axes.
